(19) United States
(12) Patent Application Publication
(10) Pub. No.: US 2005/0263539 A1
(43) Pub. Date: Dec. 1, 2005

(54) Dispensing container

(76) Inventors: Anne Elizabeth Haggerty, Belleville, NJ (US); Jeffrey Shawn Gibb, Boonton, NJ (US); Davide Sergio Nicosia, New York, NY (US)

Correspondence Address: STITES & HARBISON PLLC, 1199 NORTH FAIRFAX STREET, SUITE 900, ALEXANDRIA, VA, 22314, US

(21) Appl. No.: 10/856,769

(22) Filed: Jun. 1, 2004

(51) Int. Cl. B65G 59/00; G07F 11/16; B65H 3/00; B67D 5/56

(52) U.S. Cl. 221/263

(57) ABSTRACT

A dispensing container for bead products includes a lid and a bottom part. Pulling back the lid exposes the interior of the container where the bead products are located. Recess, ridge and funnel structures at the front of the bottom part provide for feeding the beads one at a time or in a stream when the lid is pulled back. One form of the container is rectangular wherein the lid is pulled back longitudinally. Another form is V shaped wherein a shutter is provided at the end of one of the legs of the V.

### FIELD OF THE INVENTION

This invention relates to dispensing containers, and in particular it relates to a container for dispensing bead products.

### BACKGROUND OF THE INVENTION

The term “bead products” refers to small objects of every kind including mints or other candies, tablets, pills and the like, whether spherical, square, flat, oval or of any other shape, provided that the product is a shape which allows it to roll freely or slid within the container, especially from the main storage area thereof to the vicinity of the dispensing opening.

Dispensers for such bead products are known for example as shown in U.S. Pat. Nos. 1,988,134; 4,354,619; 4,502,612; 5,123,539; 5,513,774; 6,068,126 and German Publication No. DE 32 15 520 A1.

Notwithstanding the existence of previously known dispensing containers of the type for dispensing bead products, a need exists for new and improved dispensing containers.

### BRIEF SUMMARY OF THE INVENTION

It is a purpose of the present invention to provide new and improved dispensing containers for bead products.

A purpose of the present invention is to provide new dispenser containers of the present type which have a sleek ergonomic feel when held in the hand and is easily operable to dispense products by pulling back a lid to reveal the bead products in the container.

The dispensing containers of the present invention can be designed to dispense only one bead product at a time or they can be designed such that when the lid is pulled back they dispense a stream of bead products. In accordance with the present invention, when constructed to dispense one bead product at a time, the internal structure of the container will be shaped so as to permit a single bead product to be delivered into a position just under the front of the lid while the lid is closed, whereupon after the lid is slid back, only that one bead product will be delivered and the container holds back the other products.

In another arrangement, a more open passageway can be provided in the internal construction of the dispensing container such that when the lid is pulled back an unrestricted passageway is provided for the flow of bead products from the interior of the container and out the opening thereof so as to dispense a stream of bead products.

The different embodiments of the present invention can include either internal construction, i.e., either a construction to feed one bead product at a time or a construction that permits the feeding of a stream of bead products.

In accordance with one embodiment, a container of a generally rectangular shape includes a lid which rides over a bottom part which includes a front wall, side walls and a rear wall. This embodiment may include a first internal construction for delivering the bead product one at a time in the form of a recess located at the front of the bottom part and a downward projection in the lid and/or a ridge formed in the bottom part just rearward of that recess preventing additional bead products from flowing into that recess while the lid is pulled back while allowing a single bead product to flow into the recess when the lid is closed. In another arrangement, this embodiment can omit a ridge or projection so that when the lid is pulled back to open the container, a stream of bead products can flow into the recess and out of the opening.

This embodiment can be constructed with a funnel from the main part of the container to the recess so that when the lid is opened, a stream of bead products can be delivered through the funnel, to the recess, and out of the container.

In another embodiment of the present invention, the dispenser can be designed of generally V shape which provides a particularly nice ergonomic feel when held in the hand. On one leg of the V, there can be provided a sliding shutter which opens and closes. Apart from having a shutter (rather than the sliding lid of a rectangular container), this embodiment can operate in essentially the same manner as the first described embodiment. Specifically, a pair of walls can provide a funnel passageway toward a space just beneath the location where the shutter opens. As in the first embodiment, a downward projection from the bottom of the shutter and/or a ridge on the bottom part can allow one product to enter a position to be dispensed each time that the shutter is opened or in the alternative, by omitting a projection or ridge a funnel can be provided for dispensing a stream of bead products each time that the shutter is opened.

Thus, it is an object of the present invention to provide new and improved dispenser containers for bead products.

It is another object of the present invention to provide improved dispensing containers for bead products which have an improved ergonomic feel.

These and other objects of the present invention will become apparent from the detailed description which follows of the preferred embodiments.

### BRIEF DESCRIPTION OF THE DRAWINGS

There follows a detailed description of preferred embodiments of the present invention, to be read together with the accompanying drawings, wherein:

FIG. 1 is a top perspective view of a dispensing container in accordance with the present invention;

FIG. 2 is a bottom perspective view thereof;

FIG. 3 is a bottom plan view thereof, showing bead products to be dispensed in dotted lines;

FIG. 4 is a cross sectional view, taken along line 4-4 of FIG. 1;

FIG. 5 is a cross sectional view taken along line 5-5 of FIG. 1;

FIG. 6 is a perspective view of the bottom part of the dispensing container of FIGS. 1-5, showing product therein;

FIG. 7 is a top front perspective view of the embodiment of FIGS. 1-6, showing the lid in an opened position;

FIG. 8 is a partial cross sectional view taken along line 5-5 of FIG. 1 but showing a modification of the present invention;

FIG. 9 is a top perspective view of another embodiment of the invention, shown in the closed position;

FIG. 10 is a top perspective view similar to FIG. 9, but in the opened position;

FIG. 11 is a top perspective view of the bottom part of the embodiment of FIGS. 9 and 10 with the lid removed;

FIG. 12 is a cross sectional view taken along line 12-12 of FIG. 9;

FIG. 13 is a cross sectional view taken along line 13-13 of FIG. 9;

FIG. 14 is a top perspective view showing a modification of the embodiment of FIG. 9, shown in the closed position;

FIG. 15 is a top perspective view similar to FIG. 14, but in the opened position;

FIG. 16 is a top perspective view of the bottom part of the embodiment of FIGS. 14 and 15 with the lid removed;

FIG. 17 is a cross sectional view taken along line 17-17 of FIG. 14; and

FIG. 18 is a cross sectional view taken along line 18-18 of FIG. 14.

### DETAILED DESCRIPTION OF THE PREFERRED EMBODIMENTS

Referring now to the drawings, like elements are represented by like numerals throughout the several views.

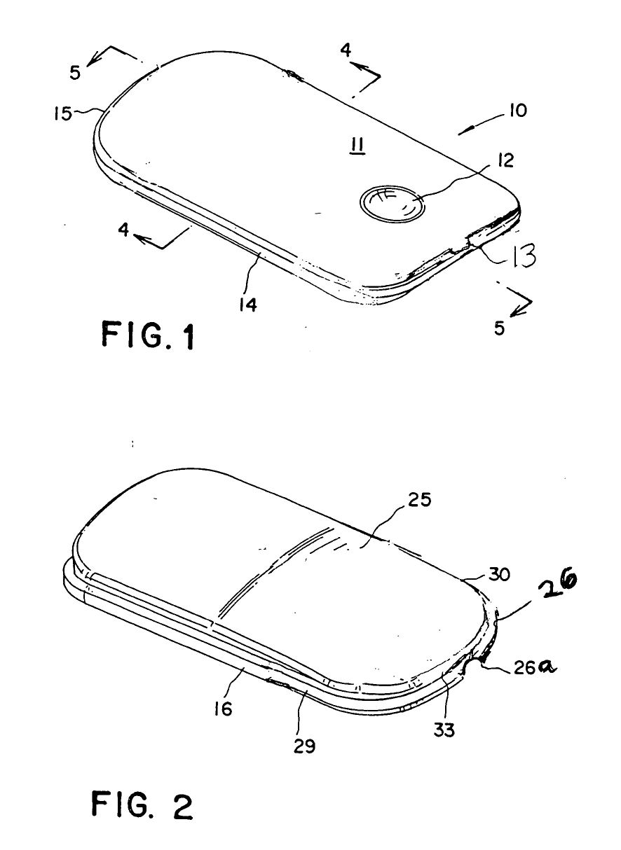

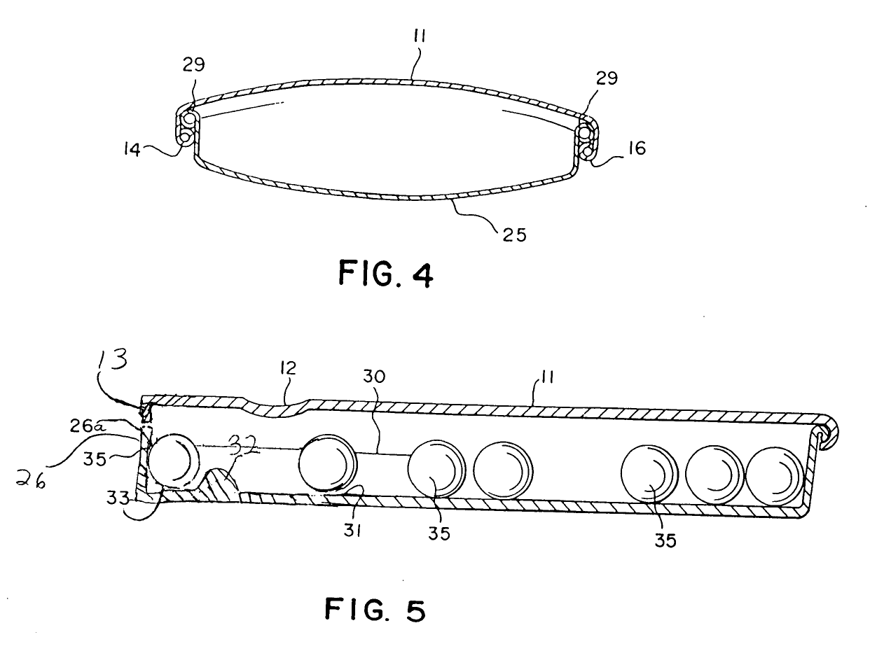

Referring to FIGS. 1-7, a dispensing container 10 comprises a lid 11 having a thumb depression 12 and projection in the form of tab 13 which will block the flow of bead products at the appropriate times as discussed below. The lid 11 includes a continuous rail including side rail 14, rear rail 15 and an opposite side rail 16, wherein the side rails 14 and 16 ride along flanges of a bottom part 25 of the dispensing container.

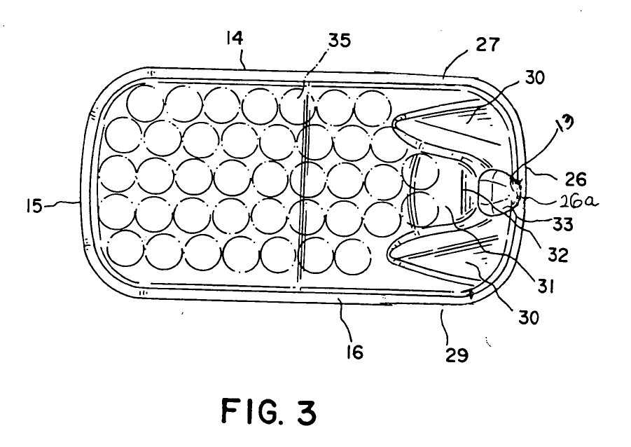

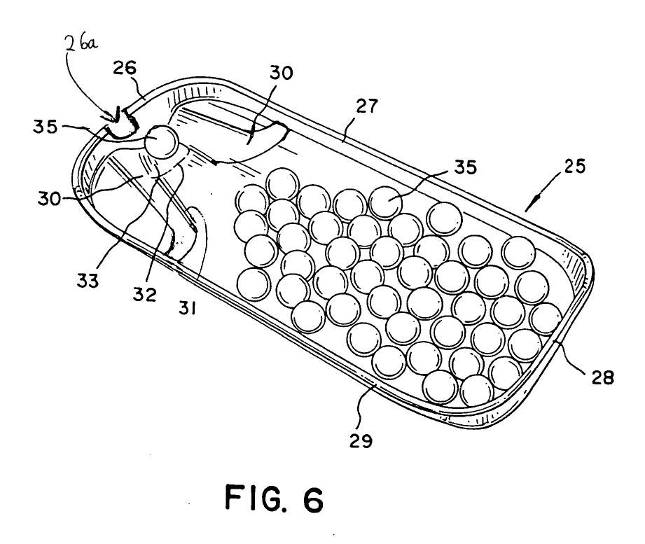

Referring to FIGS. 3 and 6, the bottom part 25 includes side walls terminating at the tops thereof by side flanges 27 and 29, a front flange 26 and a rear flange 28. Rails 14 and 16 of the lid 11 engage around and slide along the flanges 27 and 29, respectively. Referring in particular to FIG. 6, the front of the bottom part includes a pair of funnel walls 30 which are raised to form a funnel therebetween. The front of the bottom part includes a slight incline 31 which leads to a ridge 32 beyond which there is a recess 33.

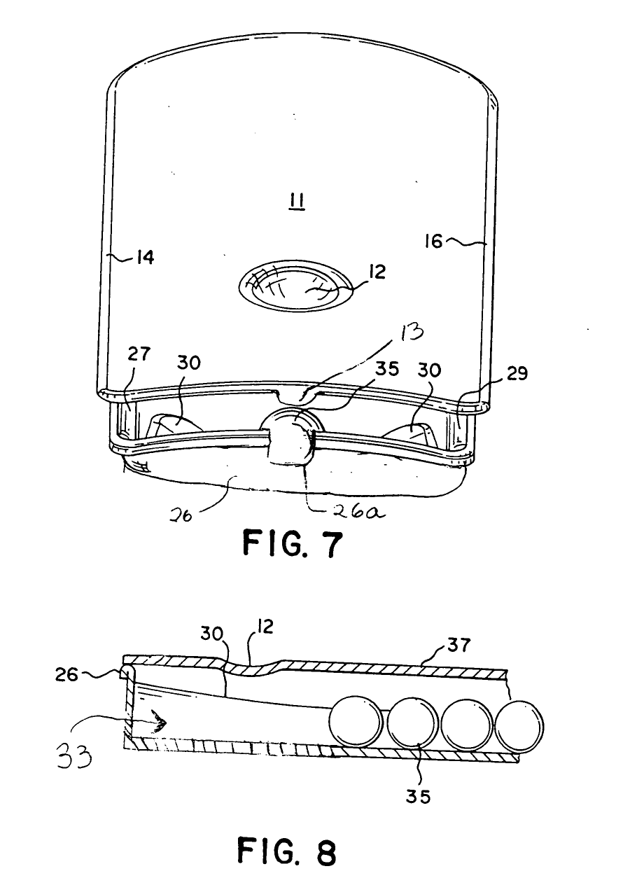

The embodiment of FIGS. 1-7 operates as follows. When in a closed position one bead product 35 would move into recess 33 which is defined by funnel walls 30 and ridge 32 as shown in FIGS. 5 and 6. Other bead products 35 could roll freely up to the bead product 35 in recess 33 but there is no room for an additional bead product in recess 33. When desiring to dispense a single product, the user holds the dispenser in one hand and with the thumb of that hand, engages the thumb depression 12 to move the lid 11 rearwardly. As the lid moves to the opened position shown in FIG. 7, the one bead product 35 remains in recess 33 while tab 13 cooperates with ridge 32 to prevent any other bead products from moving into the area of recess 33 or otherwise being dispensed. The user of course turns the dispenser upside down to gravity feed the bead product which had been located in recess 33. After that product is dispensed, the user pushes the lid forwardly, moving the tab 13 forward enough that an additional bead product can then enter recess 33.

FIG. 8 illustrates a modification of the dispensing container of FIGS. 1-7 wherein it is internally constructed to allow feeding of a continuous stream of bead products 35. Referring to FIG. 8, the modified lid 37 does not include a tab 13 or a ridge 32, but does include a pair of funnel walls 30 which define a recess 33, therebetween as in the embodiment of FIGS. 1-7. The funnel walls 30 are provided in order to form a single file for a controllable stream of dispensed bead products into recess 33 and out of the dispensing container.

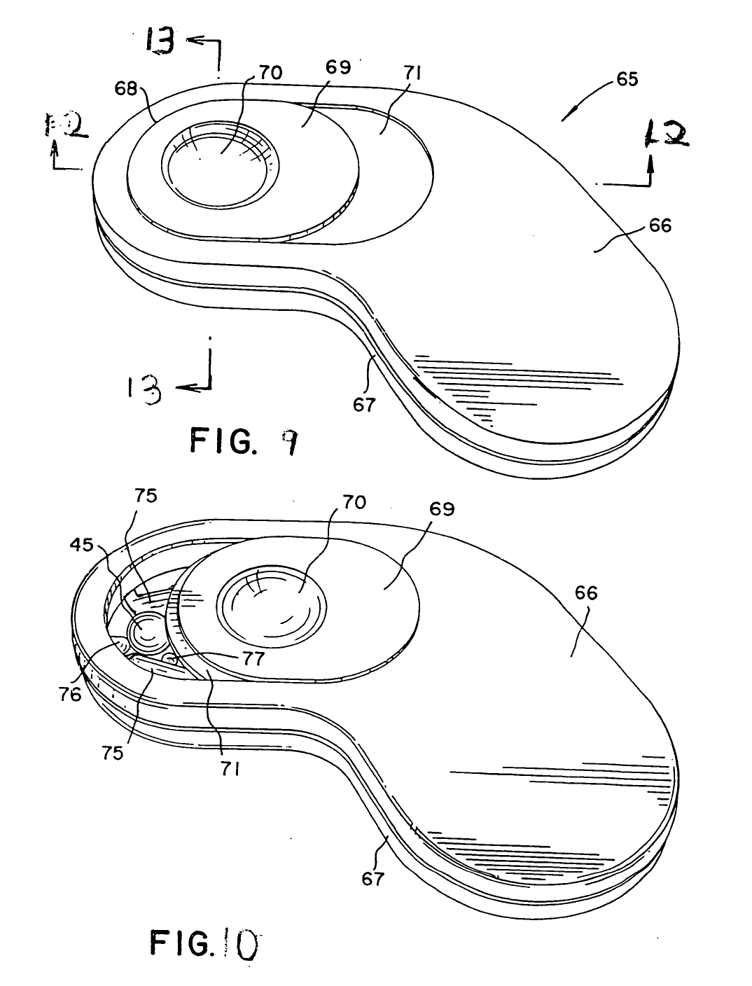

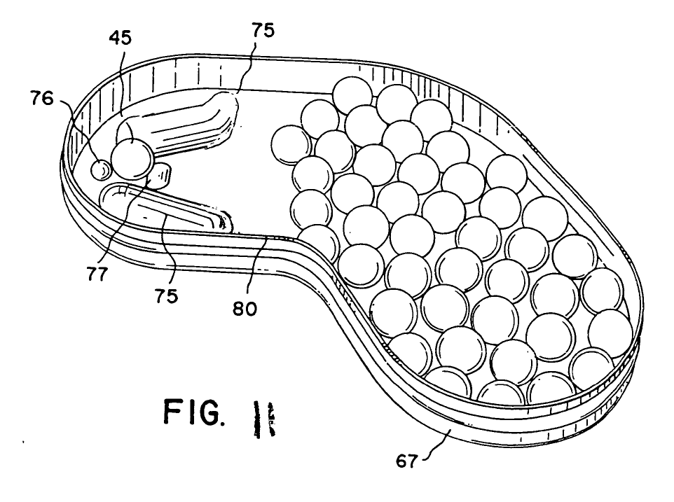

Another embodiment of the invention is shown in FIGS. 9-13. The dispensing container 65 shown in these figures is primarily characterized by its V shape which is ergonomically sleek in appearance and easy to use. FIG. 9 shows the dispensing container 65 in its closed position and FIG. 10 shows the same dispensing container 65 in its open position. The user would grasps the right hand portion of the dispensing container between his or her fingers and palm of the right hand, leaving the user's thumb free to operate the shutter 68 by the thumb depression 70 therein to move the shutter 68 between the closed position of FIG. 9 and the opened position of FIG. 10.

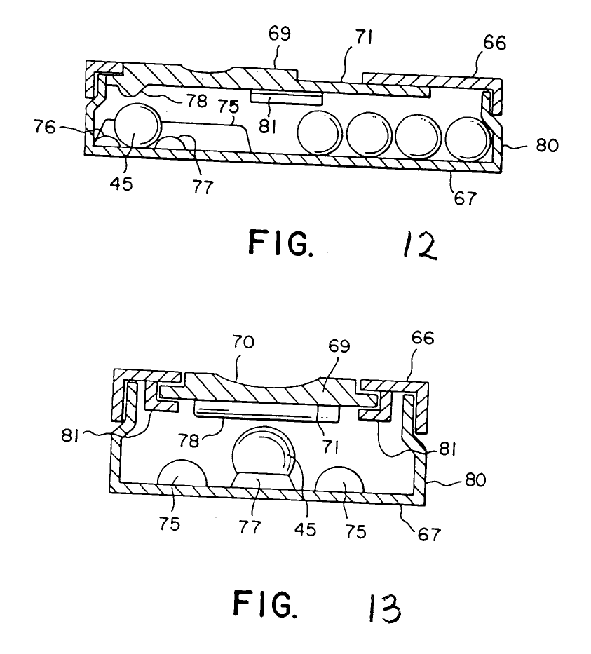

This embodiment includes a lid 66 and a bottom part 67, the latter of which is shown without the lid in FIG. 11. The bottom part 67 includes a side wall 80 which is fixed to the lid 66. As is seen in FIGS. 9 and 10, the shutter 68 includes a raised part 69, which includes the thumb depression 70, and a base part 71. Referring to FIG. 13, the lateral sides of the base part 71 ride in the L shaped flanges 81 attached to lid 66, and as shown in FIG. 12, in the closed position the front of shutter 68 abuts the wall 80.

Referring to FIGS. 12 and 13, the shutter 68 includes a downward projection 78. In the closed position of FIGS. 9, 12 and 13, this projection is forward of the recess between the bump 76 and the ridge 77 so as to allow a bead product to enter the recess therebetween. However, in the opened position of FIG. 10, this projection 78 would be positioned directly above the ridge 77, leaving a space therebetween smaller than the diameter of the bead products 45 so that the dispensing container will dispense only one bead product at a time and no additional bead products will be able to enter the recess between bump 76 and ridge 77.

Referring to FIGS. 10-13, but especially FIG. 11, the bottom part 67 includes a pair of funnel walls 75, a front bump 76 and a rear ridge 77.

Referring to FIGS. 9-13, the dispensing container 65 operates as follows. In the closed position of FIG. 9, as more clearly shown in FIG. 12, bead products may freely move in the large unobstructed area rearward of the front and within the funnel walls 75 and a single bead may enter the recess between bump 76 and ridge 77. When the shutter 68 is opened, the projection 78 in cooperation with ridge 77 will keep all bead products other than the forwardmost bead product 45 away from the opening forward of the shutter, permitting dispensing of only one bead product at a time. The shutter is then closed, permitting the bead products to move forwardly, obviously with a tilting of the dispensing container in that direction, wherein another single bead product will enter the recess between bump 76 and ridge 77 to be dispensed the next time that the shutter 68 is opened.

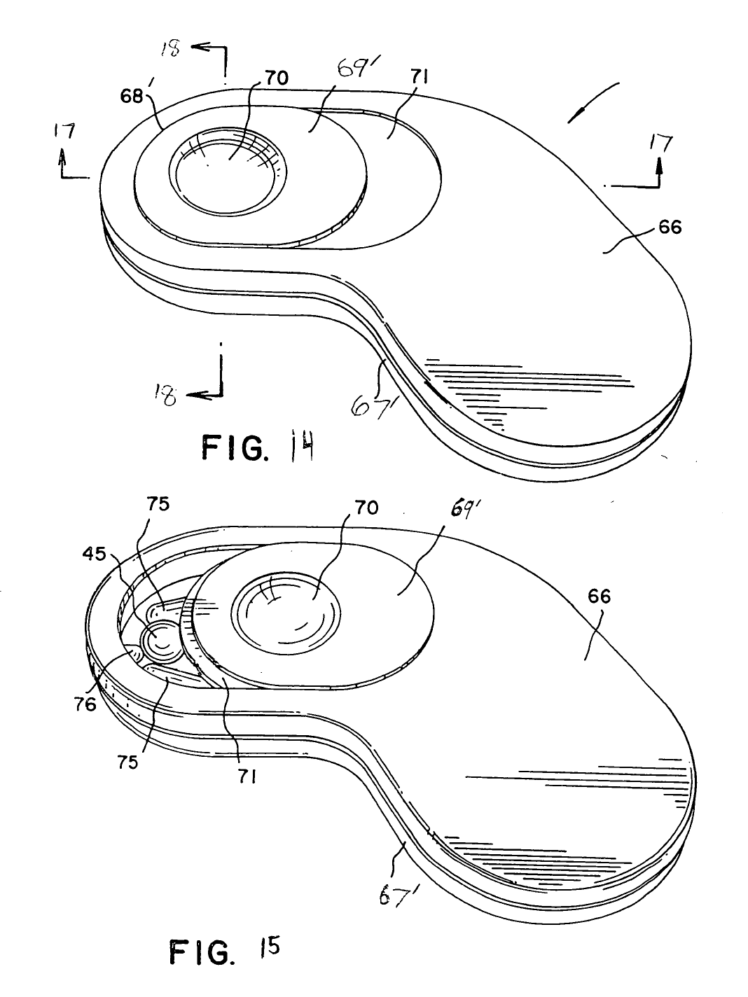

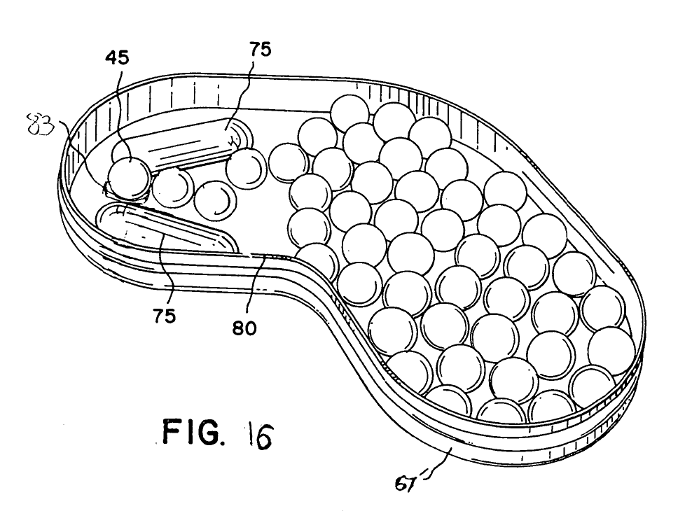

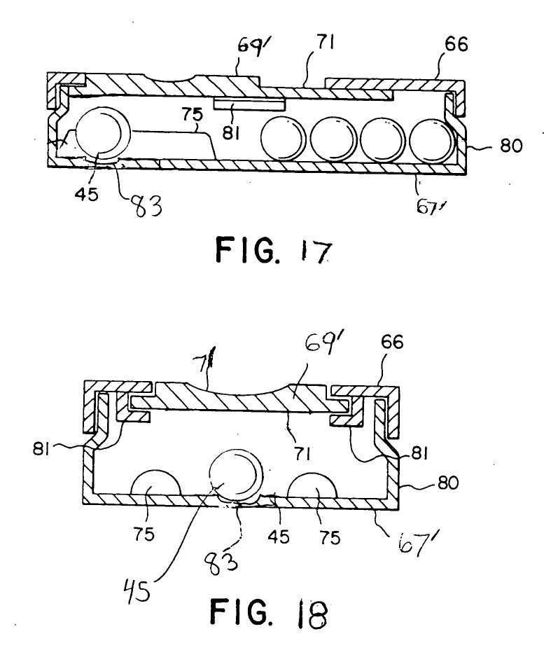

In an alternative embodiment, FIGS. 14-18 show a modification of FIGS. 9-13, where the ridge 77 and projection 78 are omitted, thus permitting the bead products 45 to form a queue behind the forwardmost bead product 45 so that a stream of bead products can be dispensed when the shutter 68 is opened. In this embodiment the elements unchanged from those previously described will use the same reference numbers as FIGS. 9-13. Elements modified from those in FIGS. 9-13 will be indicated with a prime [′].

Referring now specifically to FIGS. 14-18, raised part 69′ does not include a projection and bottom part 67′ does not include a ridge but has a recess 83. In an alternate form, recess 83 can be omitted.

In operation, while the shutter 68 is closed via raised portion 69′, any number of bead products 45 can collect between funnel walls 75, wherein one bead 45 is received in the recess 83. The remaining bead products, instead of being held against being dispensed until the next time that the shutter closes, form a queue behind the bead product in the recess 76 so that in use, after the user dispenses the product initially in the recess 76, the user can simply tilt the front of the dispensing container downwardly to allow another bead product to run down into the recess 76 and be dispensed. This process can continue indefinitely.

Although the invention has been described in considerable detail with respect to preferred embodiments, it will be apparent that the invention is capable of numerous modifications and variations, apparent to those skilled in the art, without departing from the spirit and scope of the invention.

1. A dispensing container for bead products, comprising a bottom part adapted to contain the bead products, a lid slidable relative to the bottom part to expose a portion of the interior of the container between the lid and the bottom part to dispense bead products, a front portion of the bottom part having a recess for receiving a bead product to be dispersed.

2. A dispensing container according to claim 1, wherein the front of the bottom part has a ridge over which bead products must pass from the interior of the container to reach the recess.

3. A dispensing container according to claim 2, wherein the lid has a downward projection positioned above the ridge when the lid is in the opened position, leaving a space between the projection and the ridge which is small enough to prevent a bead product from moving therebetween when the lid is in the opened position, and positioned forward of the recess when the lid is in the closed position, to permit a bead product to move into the recess when the lid is in the closed position, such that the container dispenses only one bead product each time that the lid is opened.

4. A dispensing container according to claim 3, wherein the container is rectangular and the lid slides relative to the bottom part in the longitudinal direction.

5. A dispensing container according to claim 3, wherein the container is V shaped with the lid slidable along one leg of the V and opening at the end of that leg of the V.

6. A dispensing container according to claim 1, wherein a space is provided between the bottom of the lid and the top of the bead product to be dispensed by the container, such that when the lid is in its opened position, a stream of bead products can pass from the interior of the container, and into the recess and dispensed without closing the lid.

7. A dispensing container according to claim 6, wherein the container is rectangular and the lid slides relative to the bottom part in the longitudinal direction.

8. A dispensing container according to claim 6, wherein the container is V shaped with the lid slidable along one leg of the V and opening at the end of that leg of the V.

9. A rectangular container for bead products comprising a bottom part adapted to contain bead products and a lid slidable longitudinally relative to the bottom part to open one end of the container, the bottom part having a recess formed in the forward end thereof for receiving a bead product to be dispensed.

10. A rectangular container according to claim 9, including at least one ridge on the interior of the container for preventing a bead product from moving into the recess when the container is in the opened position, while allowing a bead product to move to the recess when the lid is in the closed position.

11. A rectangular container according to claim 10, said at least one ridge including a lower ridge on the bottom part and a downward projection on the lid which is positioned above the ridge when the lid is in the opened position, such that the space between the ridge and the projection is less than the diameter of the bead products to be dispensed by the container.

12. A V shaped dispensing container for bead products, one leg of the V, near the end thereof being openable to dispense bead products.

13. A V shaped dispensing container according to claim 12, the container including a V shaped bottom part for receiving bead products and a matching V shaped top part, the top part having a lid in the form of a slidably opening shutter which is openable to dispense bead products.

14. A V shaped dispensing container according to claim 13, the bottom part having a recess just beneath the opening which is created when the lid is moved to the opened position, from which recess a bead product can be dispensed.

15. A V shaped dispensing container according to claim 14, wherein the front of the bottom part has a ridge over which bead products must pass from the interior of the container to reach the recess.

16. A V shaped dispensing container according to claim 15, wherein the shutter has a downward projection positioned above the ridge when the shutter is in the opened position, leaving a space between the ridge and the projection to prevent bead products from moving therebetween, when the shutter is in the opened position, and positioned forward of the recess when the shutter is in the closed position, to allow a bead product to move into the recess when the shutter is in the closed position, such that the container dispenses only one bead product each time that the shutter is opened.

17. A V shaped dispensing container according to claim 13, wherein a space between the bottom part and the bottom of the shutter is always greater than the diameter of a bead product to be dispensed by the container, such that when the shutter is in its opened position, a stream of bead products can pass from the interior of the container without closing the shutter.

18. A dispensing container for dispensing only one bead product each time that the container is opened, comprising a lid and a matching bottom part forming an interior, the lid being slidable relative to the bottom part to expose a front area of the interior of the container, the bottom part having structure which allows only one bead to be delivered to said front area when the container is closed, and which prevents any bead product from being delivered to said front area when the lid is opened, whereby each time that the lid is opened, the bead product in the front area, and no other bead, can be dispensed from the container.

19. A dispensing container according to claim 18, said structure comprising a ridge on the bottom part rearward of the front area and a projection on the lid that is located above the ridge when the lid is opened, at which position the distance between the projection and the ridge is less than the diameter of the bead product being dispensed, and wherein the projection is located forward of the front area when the lid is closed, to permit another bead to be delivered from the interior of the container to the front area.

20. A dispensing container according to claim 18, wherein the container is rectangular and the lid slides relative to the bottom part in the longitudinal direction.

21. A dispensing container according to claim 18, wherein the container is V shaped with the lid slidable along one leg of the V and opening at the end of that leg of the V.
